(19) United States
(12) Patent Application Publication
(10) Pub. No.: US 2016/0065306 A1
(43) Pub. Date: Mar. 3, 2016

(54) SYSTEM AND METHOD FOR GREEN COMMUNICATION FOR INTELLIGENT MOBILE INTERNET OF THINGS

(71) Applicant: Chin Sheng Henry Chong, Hong Kong (HK)

(72) Inventors: Jun Steed Huang, Hong Kong (HK); Chin Sheng Henry Chong, Hong Kong (HK); Botao Zhu, Hong Kong (HK)

(73) Assignee: Chin Sheng Henry Chong

(21) Appl. No.: 14/474,328

(22) Filed: Sep. 2, 2014

(51) Int. Cl. H04B 10/116; H04W 4/02; H04W 4/22; H04L 29/08; H04W 4/00

(52) U.S. Cl. CPC H04B 10/116; H04L 67/12; H04W 4/005; H04W 4/22; H04W 4/027

(57) ABSTRACT

A method for green communication for intelligent mobile internet of things includes: communicating with at least one mobile communication device by a lead communication device through visible light communication; determining the current communication environment between the lead communication device and the mobile communication device; controlling the operating mode of the mobile communication device according to the current communication environment; and forming a network with nodes of the network being the lead communication device and the at least one mobile communication device, configuring the lead communication device and the at least one mobile communication device as routers in the network, and transmitting multimedia information to other nodes of the network by using information shaping and compensation algorithms in a digital signal processing format. A system for green communication for intelligent mobile internet of things is also provided.

### FIELD OF THE PATENT APPLICATION

The present patent application generally relates to communication technologies and more specifically to a system and a method for green communication for intelligent mobile internet of things (IMIoT) using visible light signal processing.

### BACKGROUND

Road traffic accident is a worldwide public safety issue. There are lots of inventions, such as, the ones made by NISSAN MOTOR CO. in 2009 and Innovative Vehicle Systems in 2010. However, all these patents are traditional passive systems, where one vehicle never actively communicates with others. Even the unmanned vehicle by Google, with arrays of expensive distance measuring sensors installed only to detect the distance and work out where the car in front is.

With the past surge of the commercialization of the Internet of Things, the continuing expansion of visible light services and the increasing usage of multimedia applications, communication traffic demand has seen a steady increase. Researchers are diligently working towards disruptive technology that has not previously been given substantial attention, including visible light applications, underwater acoustic imaging and quantum radio applied to mine safety.

As an essential foundation for intelligent transportation systems, mobile nodes in network have been developed. The conventional communication system introduces EMI pollution which can cause cancer in humans and animals and also adversely affect engine and brake operations. The basic idea of vehicular ad hoc networks (or VANET) is to create a mobile network in which mobile nodes, when connected, can exchange their speed, location and other information within a certain range using the new harmless optical waves. This eliminates all the distance detection systems including radar, ultra sonic or laser and complicated distance estimation algorithms, used by most if not all car manufacturers.

The range of single-hop communication node is limited to hundreds of meters, with each node (the mobile node) being not only a transceiver but also a router. Data can be transmitted to further mobile nodes via the way of multi-hop links. VANET can provide functions, such as network information exchange, emergency event reminders and driver assistance, which can effectively avoid the collision of mobile platforms. In addition, it can be connected to other networks via roadside access points to implement functions such as traffic control and information broadcasting for auto-drive cars or road trains (cars connected as a train). The latter application is also referred to as Intelligent Mobile Internet of Things (IMIoT).

It is common to see the loss of bits and bytes in wireless networks. When mobile nodes are moving at high speed, information loss will be most likely to happen, often more frequently than incorrect information transmission. Good compensation functions must be provided. The conventional error correction and re-transmission method do not work due to the mobility because by the time re-transmission is requested, the receiver may already be out of range. On the other hand, most existing error correction algorithms deal mainly with bit errors. Unfortunately, in the high-speed moving and visible light network, bursty, missing, disordered and repeating bits, bytes or messages may happen more often than simple bit errors.

Software defined radios are gaining attention, especially in military and public safety application arenas. Nevertheless, the key issue of software network is reliability and robustness. Software tends to have more non-repeatable run-time bugs compared with hardware and as a consequence, the study towards run-time debug and reverse engineering to report online problems becomes very important.

### SUMMARY

The present patent application is directed to a system for green communication for intelligent mobile internet of things. In one aspect, the system includes: a lead communication device and at least one mobile communication device. The lead communication device is configured to communicate with each of the at least one mobile communication device, to determine a current communication environment between the lead communication device and the mobile communication device, and to control the operating mode of the mobile communication device according to the current communication environment.

The lead communication device may be configured to communicate with each of the at least one mobile communication device through visible light communication. The lead communication device and each of the at least one mobile communication device may be configured to perform front, back and side object detection, information interaction, emergency event reminders and driver assistance functions through the communication.

The lead communication device and each of the at least one mobile communication device may be configured to form a network, to be nodes of the network, to act as routers in the network, and to transmit multimedia information to other nodes of the network by using information shaping and compensation algorithms in a digital signal processing format. The lead communication device and each of the at least one mobile communication device may be configured to use an artificial intelligence algorithm to find missing bits, remove extra error bits, and correct flipped bits within the communication, the artificial intelligence algorithm containing a neural network that evolves by itself.

The lead communication device and each of the at least one mobile communication device may be configured to transmit information to other networks through a roadside unit. The lead communication device and each of the at least one mobile communication device may be configured to combine side implicit information generated by a frame marker so as to reduce error rate and improve reliability of the communication.

The lead communication device and each of the at least one mobile communication device may respectively include an interpolator for concealing errors in a damaged block of information of an information stream that includes a plurality of blocks of information. The interpolator may be configured to determine the distance between a damaged block and an undamaged block of information in the information stream and to apply a weight based on the distance to thereby interpolate the damaged block. The weight may be one of a plurality of weights that follow a Fractal distribution proportional to the distance.

The lead communication device and each of the at least one mobile communication device may respectively include an interleaving system. The interleaving system may include an input configured to receive information and a plurality of interleavers having respective associated interleaving lengths. Each interleaver may be configured to interleave the information according to its respective associated interleaving length.

The lead communication device and each of the at least one mobile communication device may respectively include a de-interleaving system. The de-interleaving system may include an input configured to receive information and a plurality of de-interleavers having respective associated de-interleaving lengths. Each de-interleaver may be configured to de-interleave the information according to its respective associated de-interleaving length.

The system may further include means for receiving information over a communication link, means for analyzing the received information to determine conditions of the communication link, means for adapting an interleaving length based on the determined conditions, and means for interleaving the information to be subsequently transmitted on the communication link using the adapted interleaving length.

The interleaving system may include color coded markers for transmitting and receiving the interleaving length information, in front of and behind data. The position of the interleaving length information in an interleaved data stream may be controlled based on the interleaving length. The de-interleaving system may include an input for receiving marked information and an input for receiving a marker.

The system may further include means for receiving a signal from a camera; means for checking whether a frame length is correct; means for using a first neural network to detect speed of the mobile communication device if the frame length is not correct; and means for using a second neural network to correct the error first and then displaying information associated with the signal. The first neural network and the second neural network may have the same structure but trained by different data, while the first neural network may utilize an atomic clock.

In another aspect, the present patent application provides a method for green communication for intelligent mobile internet of things. The method includes: communicating with at least one mobile communication device by a lead communication device through visible light communication; determining the current communication environment between the lead communication device and the mobile communication device; controlling the operating mode of the mobile communication device according to the current communication environment; and forming a network with nodes of the network being the lead communication device and the at least one mobile communication device, configuring the lead communication device and the at least one mobile communication device as routers in the network, and transmitting multimedia information to other nodes of the network by using information shaping and compensation algorithms in a digital signal processing format.

The method may further include using an artificial intelligence algorithm to find missing bits, remove extra error bits, and correct flipped bits within the communication, the artificial intelligence algorithm containing a neural network that evolves by itself.

In yet another aspect, the present patent application provides a method for green communication for intelligent mobile internet of things. The method includes: communicating with at least one mobile communication device by a lead communication device through visible light communication; determining the current communication environment between the lead communication device and the mobile communication device; controlling the operating mode of the mobile communication device according to the current communication environment; forming a network with nodes of the network being the lead communication device and the at least one mobile communication device, configuring the lead communication device and the at least one mobile communication device as routers in the network, and transmitting multimedia information to other nodes of the network by using information shaping and compensation algorithms in a digital signal processing format; and transmitting information of the lead communication device and the mobile communication device and collected traffic information to other networks through a roadside unit.

The method may further include repairing errors in communication with a combined algorithm of predictive blind compensation and shaping. The algorithm may include removing repeating errors or missed information using boundary markers. The boundary makers may be inserted periodically to a side channel.

### BRIEF DESCRIPTIONS OF THE DRAWINGS

FIG. 1 is a diagram illustrating a system that implements a green communication method for Intelligent Mobile Internet of Things (IMIoT) in accordance with an embodiment of the present patent application.

FIG. 2 illustrates two cars communicating with each other through visible light.

FIG. 3 illustrates the communication between two cars.

FIG. 4 illustrates the communication between another two cars.

FIG. 5 illustrates the communication between yet another two cars.

FIG. 6 illustrates a frame structure of a data marker.

FIG. 7 illustrates a neural network used to correct errors in communication.

FIG. 8 is a flow chart illustrating data processing with neural networks depicted in FIG. 7.

FIG. 9 illustrates the implementation of an atomic clock.

FIG. 10 illustrates a LIN protocol format.

FIG. 11 is a block diagram of a communication device incorporating a marking system in accordance with an embodiment of the present patent application.

FIG. 12 illustrates a layer structured marking format in accordance with an embodiment of the present patent application.

FIG. 13 illustrates a marking system according to another embodiment of the present patent application.

### DETAILED DESCRIPTION

Reference will now be made in detail to a preferred embodiment of the system and the method for green communication for intelligent mobile internet of things disclosed in the present patent application, examples of which are also provided in the following description. Exemplary embodiments of the system and method disclosed in the present patent application are described in detail, although it will be apparent to those skilled in the relevant art that some features that are not particularly important to an understanding of the system and method may not be shown for the sake of clarity.

Furthermore, it should be understood that the system and method disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

Embodiments of the present patent application described hereafter present an active positioning foundation for intelligent transportation systems. The active mobile nodes for this purpose in the networked cars have been developed. Optical light network is used to fulfill this task, since the conventional communication system introduces EMI pollution, which can cause cancer in humans and animals and may also adversely affect engine and brake operations.

Cross-layer error correction techniques are provided according to one broad aspect of the present patent application and may be used on top of such solutions as FEC coding and error concealment schemes to reduce errors.

An embodiment of the present patent application involves extending marking and error concealment to a multi-layer, preferably Fractal, concept to relieve the effects of both visible light error and network congestion. The multi-layer concept may be used in communication devices to enable the transfer of multi-color light communications over narrowband communication links. In some implementation, adaptive runtime algorithms and in-circuit measurements are also used within a new distributed software defined radio architecture setting to provide improved link quality over various narrowband communication systems, including underwater, on land, under mine and in deep space.

According to an embodiment of the present patent application, interleave length, instead of coding rate, is adjusted to effectively reach a compromise between theoretical performance and the difficulty of actual implementation. For example, interleaver gain over air space may be varied by using the methodology of matching the structure of a multi-layer interleaver with that of the visible light link error. The mechanism can be used to achieve substantially similar matching between interleaver gain and other types of error, such as congestion-caused “burst error”, thereby improving long distance link quality and the feasibility of broadband communications in band-limited communication systems.

Both of these matches may lead to a Fractal structured multi-layer interleaver where the length of the each interleaver follows a discrete Fractal distribution. The parameters of the marking can be adjusted according to the environment. Due to the statistical character of Internet Protocol (IP) traffic, for example, the chance of having both burst error on a visible light link and congested forward Internet is small. With the adaptive schemes as disclosed herein, there is no need to lock a static design to the worst case.

The active coordination involving the training and the on-the-fly dynamic changing of interleaver parameters automates the initial deployment of a system and it is self-adjusting throughout its lifetime.

Although wired and visible light links represent examples of the communication links to which implementation of the invention may be applied, it should be appreciated that the present patent application is in no way limited to coping with common types of wired and visible light links only. If desired, implementations of the embodiments of the present patent application may be used to improve link quality of other less common types of communication link, such as those used in underwater communications, legacy satellite systems and advanced deep space communications. Illustrative exemplary systems to which the embodiments may be adapted include satellite systems, such as LEO (Low Earth Orbit), MEO (Medium Earth Orbit), GEO (Geostationary Earth Orbit), HEO (Highly Elliptical Orbit), Stratospheric Balloon or Helicopter and other systems, such as terrestrial communication systems, including Personal Area Networks, Microwave, Cellular or any of combinations thereof.

Implementations of the embodiments of the present patent application disclosed herein may also be useful for future deep space communication, where neutrino will be used to carry quantum information. Bandwidth will be more limited and the pink noise experienced may have an astronomically long burst.

The principles disclosed herein are also substantially independent of system architecture and may be used for virtually all network architectures, including P2P (Point-to-Point), PMP (Point-to-Multi-Point) or mesh architecture, for instance.

The embodiments of the present patent application are also insensitive to the access method and may be applied to TDMA (Time Division Multiple Access), FDMA (Frequency Division Multiple Access), MF-TDMA (Multi-Frequency TDMA) or any other access method. Similarly, the embodiments are insensitive to any duplexing method and can be employed for TDD (Time Division Duplexing), FDD (Frequency Division Duplexing) or any other duplexing method.

FEC for visible light communications is usually done with fixed coding length, assuming some typical error pattern over the air. In reality, the RF (Radio Frequency) environment changes, especially for mobile and semi-mobile cases. In a connected car link application, for example, communications may normally take place between a leader car and follower cars. The link information is further forwarded to a fixed road side unit through the Internet. The error pattern on the visible light link can change dramatically depending on whether the car is on highway or whether the car is moving slowly on a congested downtown road. The loss pattern on the Internet link can change dramatically depending on the transfer path of the data and its final destination.

On the other hand, sending position information and sending other non-real-time parameters also have different requirements on error correcting capability for their particular error patterns. As a consequence, fixed marking might not generally offer the best performance for link and other types of information.

One basic rule which could be implemented in accordance with an implementation of the embodiments of the present patent application is when sending non-real-time data, such as, the mileage of a car, use a relatively long interleave and when streaming position data, use a shorter interleave. A set of a number of layers and an interleave length on each layer may be defined to fit different message size, frame rate, data rate and visible light and Internet environment type conditions.

For example, Message/Frame level marking may be used on top of Bit/Byte level interleave when a message is being transferred through a WAN (Wide Area Network). A small database may also be constructed to learn and set the optimized interleave size and dimension.

Different error recovery algorithms on a Message layer may similarly have different sensitivities to different types of error. Thus, an error recovery algorithm may also be switched to match interleave length.

Message loss patterns on the Internet change as well, depending on the path of the message. As such, this factor may also be taken into consideration. Multi-dimensional decisions may be made to optimize the size and dimension of marking. For example, either or both of the dimension and the size may be adjusted in accordance with an aspect of the invention for matching with a current operating environment of a visible light communication device.

According to one broad aspect, an embodiment of the present patent application provides an interleaving system including an input configured to receive information and a plurality of interleavers having respective associated interleaving lengths. Each interleaver is configured to interleave the information according to its respective associated interleaving length.

Another embodiment of the present patent application provides, in another aspect, a de-interleaving system including an input configured to receive information and a plurality of de-interleavers having respective associated de-interleaving lengths. Each de-interleaver is configured to de-interleave the information according to its respective associated de-interleaving length.

A method for processing information is also provided in another embodiment, which includes receiving information over a communication link, analyzing the received information to determine conditions of the communication link, adapting an interleaving length based on the determined conditions and interleaving the information to be subsequently transmitted on the communication link using the adapted interleaving length.

An interleaving system according to another embodiment of the present patent application includes color coded markers for transmitting and receiving the length information, in front of and behind the data, wherein the position of the information in an interleaved data stream is controlled based on the length.

A related de-interleaving system according to another embodiment of the present patent application includes an input for receiving marked information and an input for receiving a marker.

A software-defined communication network architecture according to another embodiment of the present patent application is also provided. This architecture may include a communication device component for implementation at a mobile visible light communication device and a lead device component for implementation at a lead system with which the visible light communication device is configured to communicate.

A related method of providing a software-defined visible light communication network may include operations, such as providing a communication device software component at a mobile visible light communication device and providing a lead device component at a lead system with which the visible light communication device is configured to communicate.

A method for analyzing software interactions provided by another embodiment of the present patent application includes operations such as identifying software objects which interact, identifying messages the software objects exchange with corresponding calls being identified by method signatures, and identifying a control flow and corresponding conditions involved in interactions between the software objects.

A run-time method for analyzing the software code provided by another embodiment of the present patent application includes generating an execution trace, applying consistency rules to the execution trace, and generating a sequence diagram from the execution trace and the consistency rules.

An interpolator for concealing errors in a damaged block of information of an information stream that includes a plurality of blocks of information is provided by another embodiment of the present patent application. The interpolator is configured to determine the distance between a damaged block and an undamaged block of information in the information stream and to apply a weight based on the distance to thereby interpolate the damaged block, wherein the weight is one of a plurality of weights which follow a Fractal distribution proportional to the distance.

In a further aspect, (a) determining the distance between a damaged block and an undamaged block of information in the information stream, (b) selecting a smoothing factor from a plurality of smoothing factors based on the distance, the plurality of smoothing factors following a Fractal distribution proportional to the distance, and (c) applying the selected smoothing factor to the undamaged block are the steps used to interpolate the damaged block.

According to another embodiment, in a communication system in which a lead communication device is configured to communicate with each of at least one mobile communication device, the lead communication device may determine the current communication environment between the lead device and each mobile device and control the operating mode of each mobile device depending upon the current communication environment.

According to another embodiment, a related method of managing communications between a lead communication device and a plurality of nearby mobile communication devices may include determining, at the lead device, a current communication environment between the lead device and each mobile device and controlling an operating mode of each mobile device depending upon the current communication environment.

According to another embodiment of the present patent application, a green collision avoidance communication method for IMIoT and an associated instant or live compensation method for high-speed wireless link is provided. The communication method includes functions of live traffic information collection by each node and information sharing within VANET between all the nodes. Information can also be transmitted to other networks through roadside units. Reliable repairing algorithm may be employed to help prevent car accidents.

The implementation of the system contains user interface, signal generator, optical launch-end machine, harmless light source, optical transmit system, optical receiver system, optical detector, optical receive-end machine, information digital processing unit and terminal monitor. Since wireless optical transceiver can share the power generated by mobile platforms, external power supply is not needed. Optical signal frequency can be adjusted to insert the marker. Wireless transceiver converts optical signals into electrical signals which are transmitted into an information signal processing unit. They will be further processed and displayed on a terminal monitor.

Another embodiment of the present patent application provides a method for compensating information loss for the green wireless links. The compensation method works as an integrated unit by combining side implicit information generated by the frame marker, which can reduce the error rate and improve the reliability of communication. They are parts of the information-processing unit.

In another embodiment of the present patent application, the method includes repairing errors in communication with a combined algorithm of predictive blind compensation and shaping. The algorithm includes removing repeating errors or missed information using boundary markers. The boundary makers are inserted periodically to a side channel.

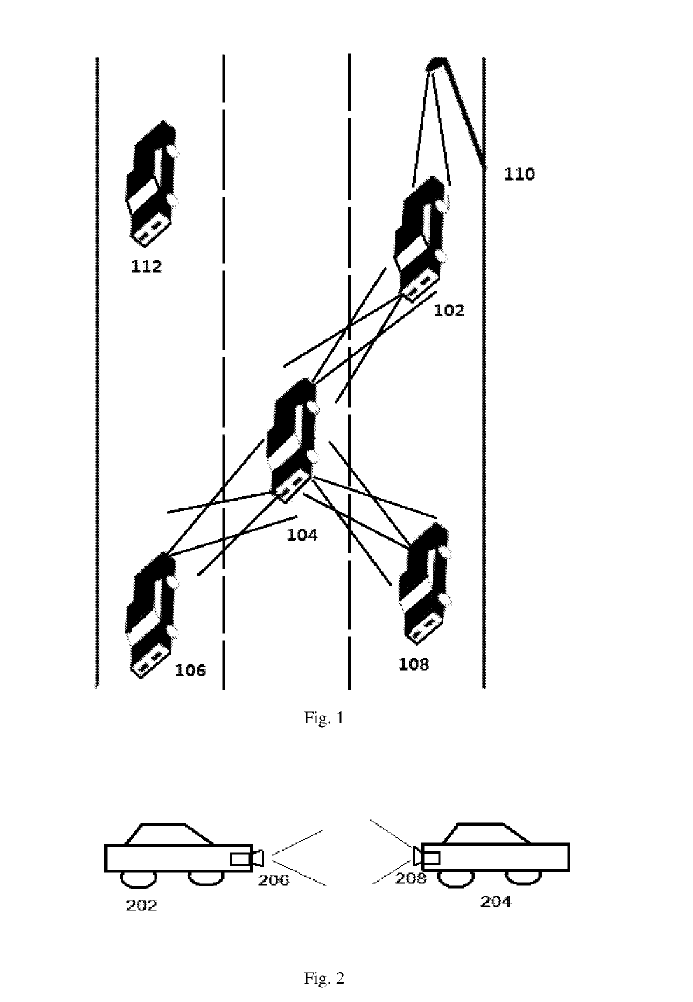

FIG. 1 is a diagram illustrating a system that implements a green communication method for Intelligent Mobile Internet of Things (IMIoT) in accordance with an embodiment of the present patent application. In terms of its general high-level structure, the system is an ad hoc network. It should be appreciated that the particular components and system topology shown in FIG. 1 are intended solely for illustrative purposes. The present patent application is in no way limited to any particular type of communication device or system. Implementations of the present patent application may be executed in communication having further, fewer or different cars with different interconnections than those shown in FIG. 1. In addition, some implementations of the present patent application may be done at a particular device, while others may involve components or modules which are implemented at multiple locations, cars and road site units.

Referring to FIG. 1, a car 112 has all lights off and it cannot be detected at all. A car 106 does not have the system but has daylight running lights on so that it can be detected by a car 104. The car 104 has a phase I basic system which is configured to detect the presence of the car 106 and inform its driver when they get close to each other. A car 108 has a phase II camera system plus GPS reading and is configured to communicate with the car 104 offering its GPS position to the car 104. A car 102 has an advanced phase III built-in system which is configured to not only communicate with the Car 104 but also communicate with a roadside unit 110, and configured to forward a weather report to the car 108 via the car 104. In return, the car 108 is configured to provide the car 102 with its camera view which otherwise cannot be seen by the car 102 under foggy conditions. This virtually extends the camera view of the car 102. The car 102 can auto-drive along and form a road train with the car 108. The car 102 is configured to apply intelligent compensation to predict and recover any missing data, making the communication reliable under all weather conditions. It is noted the phases I-III mentioned above will be described in more detail later.

It is noted that many different types of equipment which may be used to implement the various components of the system and accordingly these components are described only briefly herein.

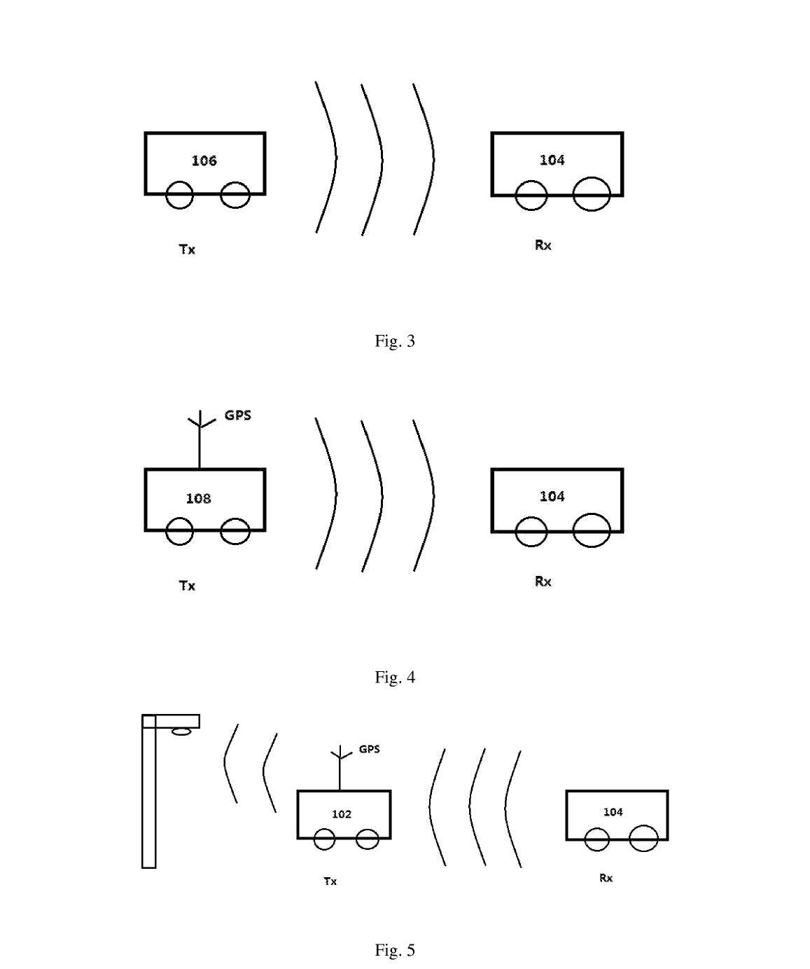

Any two of the cars are communicating with each other through visible light as shown in FIG. 2. Referring to FIG. 2, a transmitter 208 of a car 204 is sending information to its follower car 202 through its receiver 206. Typically such information could be: “the road is getting pretty wet and crowd, and don't follow me too closely!” The official basic messages scope can be found in SAE J2735 SE standard. Advanced messages such as road friction level, light condition and etc. can be found in ITS NTCIP1213.

FIG. 3 illustrates the communication between the car 106 and the car 104. Referring to FIG. 3, the Tx of the car 106 is a transmitter. This is a day time light installed on the four corners of the car 106. The Rx of the car 104 is a receiver. It is a special camera configured to detect light intensity and use the pre-trained neural network to learn and predict the distance.

FIG. 4 illustrates the communication between the car 108 and the car 104. Referring to FIG. 4, the Tx of the car 108 is a transmitter with GPS reading. This is a color changing LED light installed on the four corners of the car 108. The Rx of car 104 is the receiver. It is a special camera that is configured to detect the color change of the light and use the pre-trained neural network to learn and predict errors.

FIG. 5 illustrates the communication between the car 102 and the car 104. Referring to FIG. 5, the Tx of the car 102 is the transmitter with the actual image. This is the tracking light installed on the four corners of the car that can follow the lamp post angle. The Rx of the car 102 is the receiver. It is a camera that can handle the forwarded image from the car 108 through car 104.

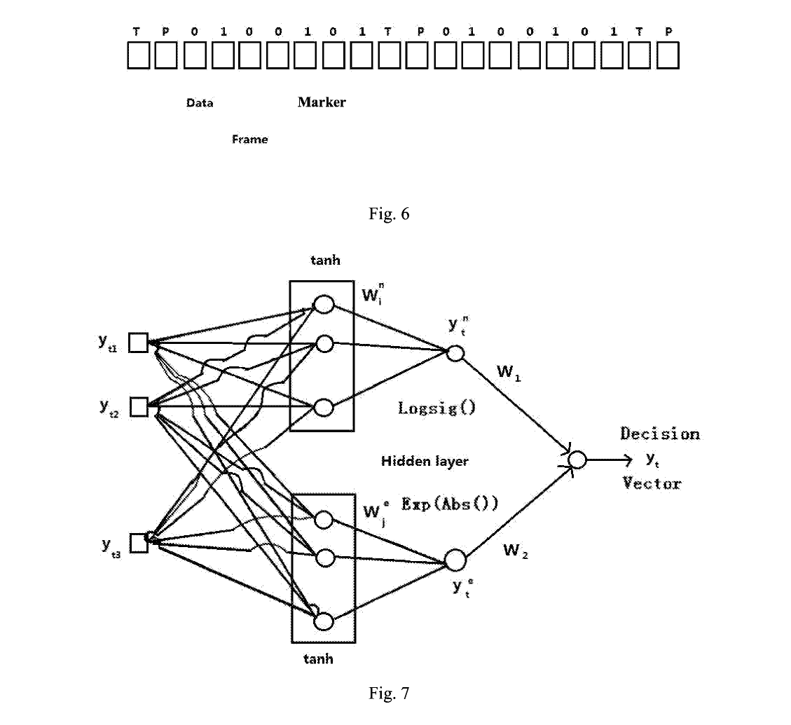

Based on the frame marker, an example of the frame structure is shown in FIG. 6. Referring to FIG. 6, the length of the data is fixed, so is the marker. The color of the data and the marker components are different. If any of the received length is changed, the algorithm will repair it, put it back to the predefined length by cutting out the extra or make up the missing one, based on the best guess from the neural network prediction. The neural network used to correct the error is shown in FIG. 7. Referring to FIG. 7, the input is the frame with errors. The output decision vector is the best guessed result. The weight is pre-trained with field data.

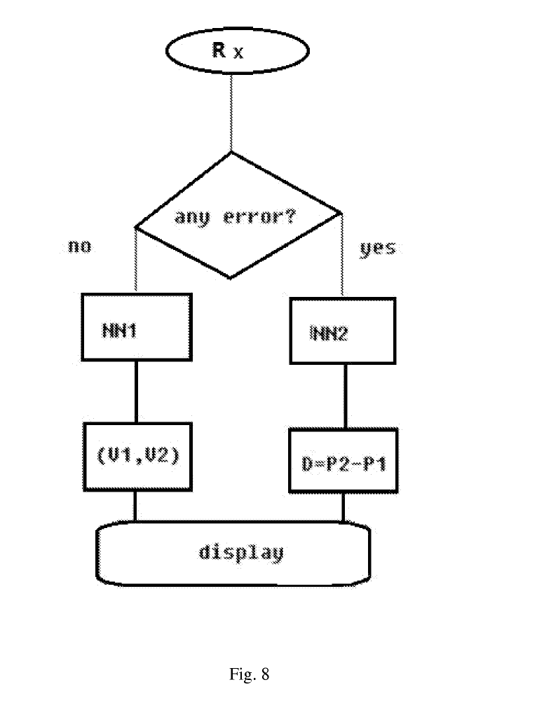

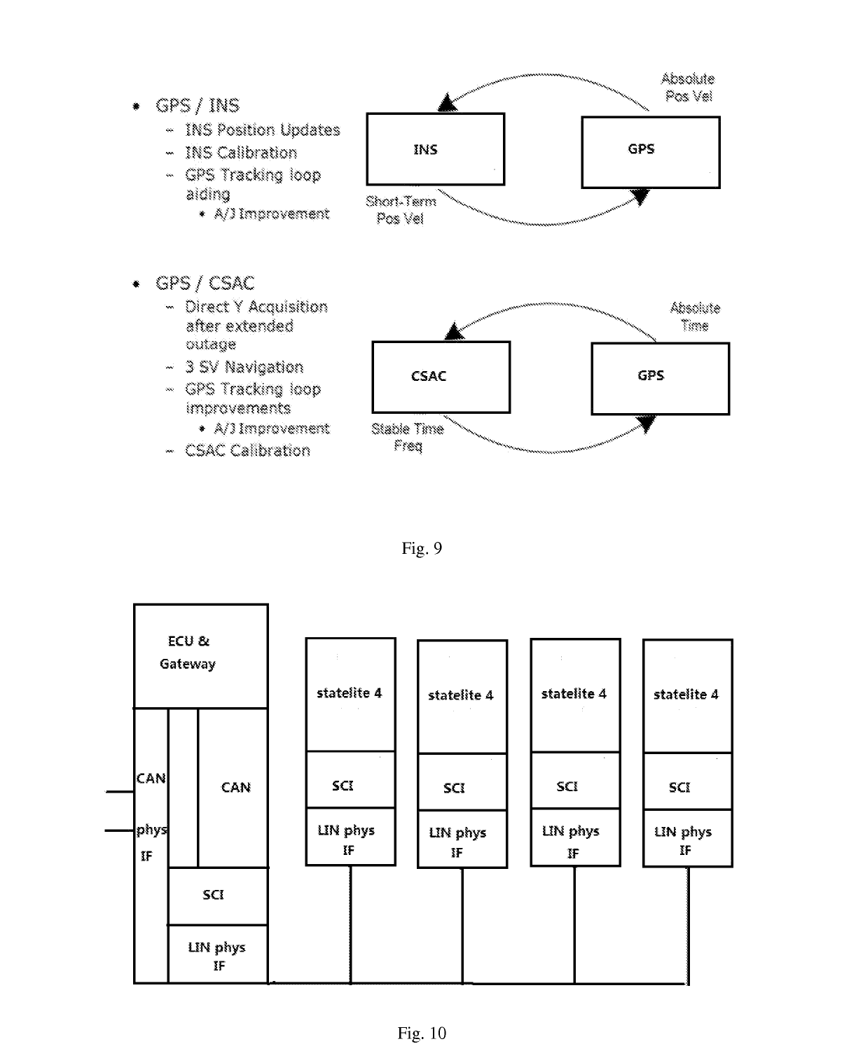

FIG. 8 is a flow chart illustrating data processing with neural networks depicted in FIG. 7. Referring to FIG. 8, when a signal is received from the camera, it is configured to first check if the frame length is correct; if not, it will use Neural Network (NN1) to detect the speed; if yes, it will use Neural Network (NN2) to correct the error first and then display the information associated with the signal, such as the position. The distance between two vehicles is computed by position P2 and P1. The speed is calculated from the weighted mean of Doppler shift of data frequency and marker frequency. NN1 and NN2 have the same structure, except that they are trained by different data. NN1 needs an accurate time and position, which is realized by using the atomic clock shown in FIG. 9.

Before further describing implementations of the embodiments of the present patent application, it may be helpful to first review the basic concept of the LIN protocol format, which is illustrated in FIG. 10 and may be used in implementing the embodiments.

The master in a lead car has control over the whole Bus and Protocol. The master controls which message at what time is to be transferred over the bus. It also does the error handling. To accomplish this task the Master does the following:
sending Sync Break;
sending Sync Byte;
sending ID-Field;
monitoring Data Bytes and Check Byte and evaluating them on consistence;
receiving WakeUp Break from slave nodes when the bus is inactive and some action is requested; and
serving as a reference with its clock base (stable clock necessary);

For the Slave, the Slave is configured to determine whether one of 2-16 Members on the Bus is receiving or transmitting data when an appropriate ID is sent by the master. More specifically, Slave snoops for ID. According to ID, Slave determines whether to receive data, transmit data, or do nothing. When transmitting, the Slave sends 1, 2, 4, or 8 Data Bytes, and sends Check-Byte. It is noted that the node serving as a Master can be a Slave too.

The LIN format is designed to contain the car information of a connected car in a flexible, extensible format which facilitates interchange, management, editing and presentation of the real time information. This presentation may be ‘local’ to the system containing the control of the car or may be via the visible light network to inform or control the other car. The message format is designed to be independent of any particular delivery protocol while enabling efficient support for inter-car and intra-car delivery in general.

The marker format includes multi-dimensional structures on top of the LIN format, a unique tag and a length identifying each layer. The color-coded marker describes a hierarchy of message giving information, such as position, speed, acceleration and etc. The higher the marker of layer, more the information is provided.

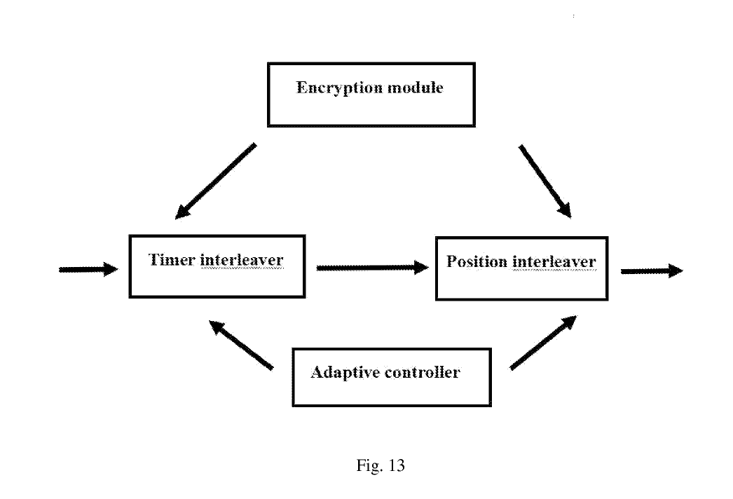

As can be seen in FIG. 12, the marker has such a highly structured encoding format, that missing one byte or even one bit over a visible light link, for instance, can be detected. Since the whole structure is known and fixed, nothing can go wrong during the reception at a receiver. In FIG. 12, the layer structured marking format is shown, in which the shorter block is the marker, while the longer block is the data for that particular layer. Only two layers are shown in FIG. 12, but the structure can be extended to any number of layers, only limited by the number of colors available. For 1 layer, 2 colors are needed. For 2 layers, 4 colors are needed. For 3 layers, 8 colors are needed, and so on. The unique structure here is that the marker can contain data, and data can contain marker. If one is missing, the other can help. It is noted in a conventional structure, a maker never contains data, and when the marker is missing, there would be no way to recover it.

Conventional FEC can reduce error rates but at the cost of increased bandwidth. According to an embodiment of the present patent application, error rates are improved without incurring bandwidth overhead using marking techniques. Since the typical message in car control is known and fixed, there is not much pure Gaussian noise like message at all.

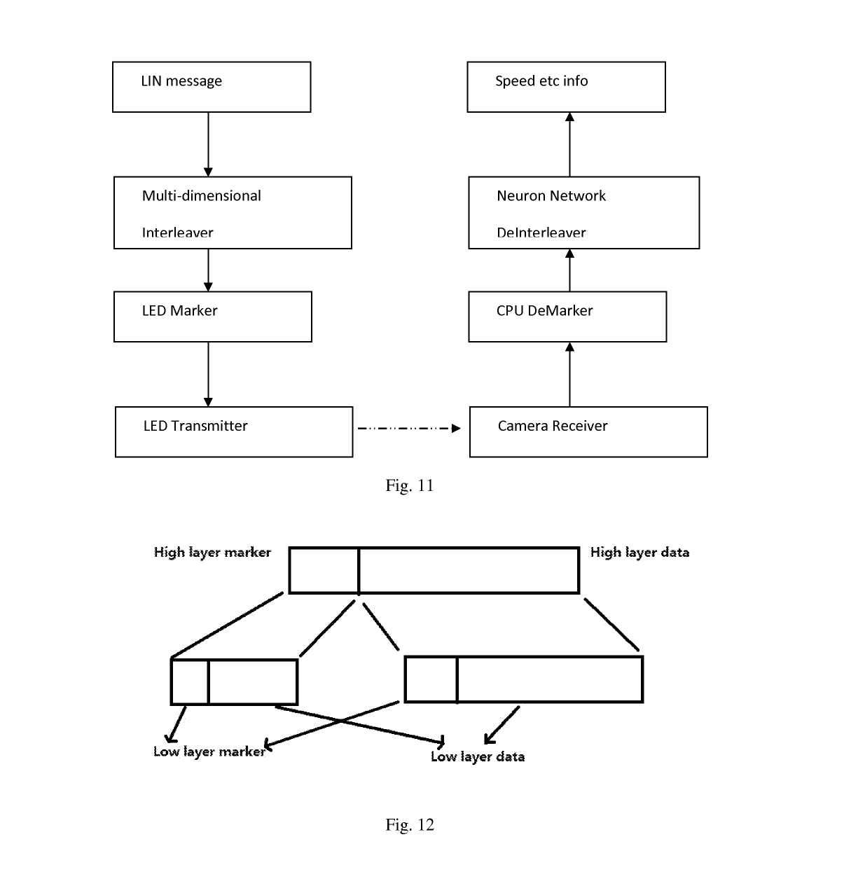

FIG. 11 is a block diagram of a communication device incorporating a marking system in accordance with an embodiment of the present patent application. Referring to FIG. 11, the device includes an input link source, such as a link camera; a link interleaver, illustratively an LIN message encoder, operatively coupled to the input link; a marking system operatively coupled to a link transmitter; a channel camera receiver operatively coupled to the CPU processing system and configured to decode the color; and a neuron network based on fast de-interleaver and configured to decode the missing information.

Although the CPU demarker link source would normally be implemented using hardware, such as ASIC, PLDs (Programmable Logic Devices), FPGAs (Field Programmable Gate Arrays), while other components of the device such as DSP or embedded CPU may be implemented either partially or entirely in software which is stored in a memory and executed by one or more processors. These processors may include, for example, microprocessors, microcontrollers, DSPs, other processing devices and combinations thereof.

The specific type of each component will be implementation-dependent. The particular structure and operation of the interleaver may be different for different formats of link information. The channel conditions, the receiver and the transmitter will similarly be dependent upon ad hoc communication protocols and which information to be transmitted using the media.

In addition, the present patent application is in no way restricted to implementation with communication devices or other types of device having the specific structure shown in the drawings. Different or fewer components, with different interconnections, may be used in a device in which an implementation of the present patent application can be done.

According to another embodiment, a single communication device incorporates both a transmit chain and a receive chain to enable both transmission and reception of information. In this case, a transmitter and a receiver may be implemented as a single component, generally referred to as a transceiver. Other components or certain elements thereof may similarly be used in both a transmit chain and a receive chain.

FIG. 13 illustrates a marking system according to another embodiment of the present patent application. Referring to FIG. 13, the marking system employs a marking path which includes two interleavers, sending time and position, each having a respective marking length. These interleavers include a time interleaver, a position interleaver, although other types and lengths of interleavers may also or instead be provided in a marking system. It is note that each marker is delivered in their respective light color, different from the LIN message data itself. The lead car usually is the master and the follower cars are slaves.

Each interleaver in the marking system interleaves input information according to its respective marking length and together. The interleavers form a marking path which provides an overall or aggregate marking length.

An interleaver receives information, illustrative symbols from a fixed alphabet as its input and produces the identical information, symbols in this example, at its output in a different temporal order. Interleavers may be implemented in hardware or partially or substantially in software. The order of the interleaver can be dictated by a password which is secure or known to everyone, depending on whether security is a concern.

Used in conjunction with high level error correcting codes, marking may counteract the effect of communication errors, such as burst errors. It is understood that marking is a process performed by an interleaver. Namely, marking is a digital signal processing technique used in a variety of communication systems. In one implementation, this marking is done with message FEC (Forward Error Correction) that employs error-correcting codes to combat bit errors by adding redundancy to information messages before they are transmitted. At the higher layer, an error recovery algorithm is matched with a particular FEC and interleave pattern. Because marking disperses sequences of bytes in a byte stream so as to minimize the effect of burst errors introduced in transmission, marking can improve the performance of FEC and bit loss recovery using the neuron network and thus increase tolerance to not only the transmission error but also the transmission loss of bit.

Other components may also be provided in an implementation of the marking system, including an interleaver controller to control which interleavers are active in the marking path and thus the aggregate marking length at any time. A memory for storing information during marking and mappings between information types, operating conditions and marking lengths, for example, a transceiver (which may be a transceiver which is also used for transmitting and/or receiving information, or a different transceiver) for receiving and transmitting marking control information, such as error information, communication link information, etc., and an encryption module are described in more detail hereafter.

The controller represents a piece of hardware, software, or combined hardware/software component which controls the particular ones of the interleavers and is active at any time in the marking path of the marking system. Interleavers may be enabled/activated or disabled/deactivated to provide a desired aggregate marking length on the marking path.

Various techniques may be used by the controller to enable and disable interleavers in the marking system. In hardware-based implementations, hardware chip selects or analog inputs may be used to enable an interleaver. Function calls represent one possible means of enabling software-based interleavers. Other techniques for enabling and disabling interleavers, which will generally be dependent upon the type of implementation of the interleavers, may be used in addition to or instead of the examples described above.

The controller may control the marking system 82 on the basis of control information received through the transceiver. Received control information may include, for example, monitored communication link information for a communication link over which interleaved information is to be transmitted and/or a command to activate one or more interleavers having particular associated marking lengths. Control information may also be transmitted to a nearby marking system to be used by that system in setting its aggregate marking length.

A type of information to be interleaved may also or instead determine an aggregate marking length to be used. For example, the controller may enable and disable appropriate interleavers in the marking system to provide a first aggregate marking length where the information includes only position and a second aggregate marking length shorter than the first marking length where the information includes both position and time.

Mappings between the above and/or other conditions and corresponding marking lengths may be pre-stored in the secured memory for access by the controller. The controller may also or instead store new mappings to the memory as new security conditions and suitable aggregate marking lengths are determined.

The system uses one kind of classical interleaver, which is the block interleaver. In a block interleaver, input information is written along the rows of a matrix in the memory and then read out along the column. Therefore, in a visible light link over the IP network, an interleaver is installed as in-car devices and then each car device executes marking when a link message is transmitted. A bit based convolutional interleaver is not used at all, to simplify the design. The color coded marker is used to solve the slip of the bit problems. Each time the color is switched, it means a restart of the bit stream. If any bit(s) is missing, the neuron network is used to make up the missing piece.

There are two fundamental reasons for using a multi-layer marking system. The first is that a recent study shows that the error and loss pattern follow a so-called self-similar structure. This means the burst error can accrue on any scale, from the bit level all the way to the message level or even session level. The second reason is that even if there is no error, encryption may be desirable when the original signal goes through visible light or Internet path, to prevent access to transmissions by an eavesdropper or hacker. Dedicated encryption costs extra power and complexity. Combining the functions of encryption and marking can simplify the overall design and reduce the cost, the physical size and the power consumption.

An interleaver according to another aspect of the present patent application prevents unauthorized access of data by combining marking with encryption. In one implementation, a DES or DES-like algorithm is used in combination with an interleaver. This combination is represented in FIG. 13 by the encryption module, through which the controller or more generally the marking system, receives security information, such as, an encryption key. This key may be typed in manually by a car operator or may instead be stored default at a communication device in which the system is implemented, illustratively in a key store in the memory. In one case, the length of the encryption key is configurable upon the request of the user.

The idea of encrypting information directly with interleaving, instead of using a stand-alone encryptor, represents a very new thinking for lightweight flexible design. The key may be used to encrypt the information itself or to determine the position of the original information after marking, rather than the encrypting the actual information. The latter provides encryption which is a magnitude of about N!/2̂N, where N is the length of key, stronger than the former.

Encryption can be done multi-dimensionally using the marking system, with more than one interleaver handling encryption using sections of a single key, for example. Security information, a key, for instance, can be a combination of numerical number and alphabetical character. For a simple implementation, we can pick a number from a password, if the password is “13” and the frame interleaver 1 is used for combined marking and encryption, the first byte is swapped with the third byte in position, so on and so forth.

In one implementation, simple marking is operated at the end point device of a Link over an IP network with new visible light systems. For an interleaver having a buffer of size M, a link message to be transmitted is written to the buffer along the rows of a memory configured as a matrix of size k and is then read out along the columns. On the receiving side, the de-interleaver in a receiver writes and reads this transmitted link message in the opposite direction. The de-interleaved link message is then forwarded to other receiver components.

Multi-dimensional interleaving may be operated in a very similar fashion, except that each level of the marking is executed on different layers. Although a mark for each layer cannot be interleaved, the payload can. For a LIN message transmitted from a car to another car and forwarded to a roadside unit as described above with reference to FIG. 1, its message mark may include a mark: a Time mark which may contain a Position mark, a Speed mark which may contain both position and time, or an acceleration mark which may contain all of the above.

A special algorithm is used to manage the interleaver size according to the embodiment of the present patent application. In transmitting a link message, the situation of visible light network is reported. Link messages transmitted in a visible light network may make the devices of the visible light network, such as gateways, routers and media gateway controllers very busy. In this case, burst errors may occur due to message loss caused by network congestion or interference on the visible light path. Therefore, the control of this burst error, through adaptive marking as disclosed herein, may be particularly useful.

FIG. 13 also illustrates a burst error reduction algorithm with adaptive control. It changes the interleaver size according to information provided by the run-time algorithm. Interleaver parameter changes may be terminal-driven in some embodiments. In the system of FIG. 1, for example, when communication channel conditions between the mobile lead and the follower deteriorate, terminal demand for stronger marking may escalate and the mobile lead may grant a request from a follower terminal based on a combination of neuron network reported errors among the cluster.

In a typical ad hoc network communication system, a temporary session includes a number of messages. A message includes a number of bytes and a byte consists of a number of bits. In a seldom-happening worst case, all four levels of marking as shown can be used, i.e. to swap session, on top of swap frame, (in turn) on top of swap byte, (and again) no bit is swapped, to guarantee the color coded boundary synchronization.

A mode ID or other control information may be either exchanged at the beginning of communication using a modified SDP (Session Description Protocol) or constantly enforced by each message mark and processed by a communication processor, such as the MSP. The marker itself contains the message length information as well. At the receiving end, the ID is verified and corrected (by counting the number of bytes) if necessary first, at the channel decoder before the de-interleaving starts. This way the error correction code, such as a Reed Solomon channel decoder will maximize its error correction capability.

In a conventional error correction system, if one byte or bit is lost, the whole block of the code is shifted, and the Reed Solomon code will think every byte is a wrong byte and give up the decoding process. With the multi-dimensional interleaver described here in this embodiment, one is able to identify the missing byte using one byte color coded marker, shift back the rest of the byte or bit, and then get Reed Solomon code to work harder than usual. The description above explains how to change the interleaver size and/or dimension.

According to another embodiment of the present patent application, a special run-time algorithm is used to detect errors on each layer of a software network. Errors can happen in any layer, caused by its next lower layer or higher layer. An error happening in any layer can cause the final freeze of streaming link image through a visible light link or some other failure. The techniques described herein allow effective reporting of run-time problems, so that a control center can identify the problem, carry out analysis and take final actions, according to a learned or preset mobile database.

In a software network architecture according to an embodiment of the present patent application, the above method is used as follows. The decision related functions (such as when to switch to an operation mode) are performed at a server or control center site. Whereas part of the information collection (such as error event, interference event and Bit Error Rate) resides on a mobile device. The other part of information collection (such as the number of hops a message goes through) resides on the server itself. The run-time algorithm described above is implemented in the server, also referred to herein as a control center. The control center, preferably controls center software in the leader car, configures and controls visible light devices, link encoder devices and Internet message forwarding devices and constantly monitors itself against desired performance. In addition, less complicated and more robust watch-dog software may be written in script language, for example, for the rest follower cars, and is used to further monitor the heart-beat in each car, to make sure the entire ad hoc network is up and running around the cluster.

In an example scenario, during run-time, a mobile terminal which detects an interference event reports the event to the control center. A terminal might also or instead be capable of determining that an event is imminent or likely to occur. Based on historical interference patterns, for instance, the terminal is configured to report this to the roadside unit.

The roadside unit will then look into its database for previous records. If the reported event has happened before, it will fetch any previously used solution. It determines a solution or action to take in response to the event in the past. The solution may be to simply double or otherwise adjust the interleaver length.

A loss concealment scheme may be used, for example, for a message where some information exists. It makes use of the standard message similarity and finds the closest one.

According another embodiment, an intelligent mobile green communication method employs mobile nodes in a network. The on-board nodes include an optical wireless communication system, which is used to communicate with target detection devices equipped at each node. The system uses a harmless wireless optical transceiver. The transmitter converts electrical signals into optical signals and transmits them over the air channel. The receiver focuses optical signals on to a photoelectric detector which converts optical signals into electrical signals. The receiver acts as an object detector by monitoring the relative light intensity closely. The receiver also acts as a speed detector by monitoring the relative Doppler frequency shift of the periodical marker closely.

All of the techniques described above may be applied to the communications between the lead system, the follower system and the roadside unit. The techniques and systems described herein may be tested, for example, using computer-based simulation, actual field trial or a combination thereof. Visible light channel models and internet loss models, for instance, may be used to generate simulation graphs. For simplicity, a simulated system may include one road side internet unit, four visible light camera cars. As for field trial communications, visible light camera and control signals may be exchanged over a 50 to 100 meter range, for example. In one test setup, a transmitter is mounted on a model car, with the link quality tests using OV7962 wide angle car camera and SXH 7 color day light driving lamp LED.

The above embodiments bring a new communication concept into the motor and transport industries, not only to cars on crowded highways but also to high-speed trains on stressed railways, ships in busy water channels or even airplanes on crowded runways. The embodiments will allow the upgrade of current communication systems to avoid collisions on highways, railways, water channels or airport runways. Taking the motor-car as an example, the product can be rolled out in three phases.

In the first phase, trials can be done on accident-prone vehicles such as delivery vans or other service vehicles as well as the emerging electric cars. No roadside units are needed at this point. It will work as a basic head and sidelight detector, informing the driver that another car is around. However, if the daylight running light is not on, it will not work.

In the second phase, roadside units are still not required. Car owners can buy such an accident avoidance camera communication system as an after-purchase retrofit. If the adjacent car is not fitted with such a system, it will still work as a head and sidelight detector, informing the driver another car is approaching and at what speed. If the other car has the same system, more can be done. They can share their GPS information to guide the car or train to drive automatically.

In the third phase, when more cars are fitted with such a system, roadside units can be installed. New cars can be fitted with the system, in a so-called before-market approach, by car manufacturers. The system should also work in foggy conditions or around the corner, through the roadside units.

Many different types of implementation and realization of the present patent application are possible. Components or devices described as hardware above may alternatively be implemented partially or substantially in software. Similarly, method steps disclosed herein may be performed by hardware or implemented in software code.

Although the above description takes an example system with over-the-air or land architecture, using adaptive multi-layer schemes, focusing on marking, the general principle applies to other architectures, such as, underwater acoustic or Very Low Frequency (VLF) marine applications as well.

The concepts can be further applied to nuclear submarine or deep space systems, such as particle communication system using sub-nucleus inter-star imaging systems. For example, part of the pre-interleaving may be applied before sending information through a neutrino system, where the particle can penetrate the entire earth with almost no loss of energy. The information can be modulated on to the sub-neutron particles based on their energy level or left or right spinning characteristics.

The concept also applies to co-existing systems, such as satellite systems with terrestrial visible light systems. For example, part of the pre-interleaving may be applied before sending signals through satellite or GPRS system, without increase of any overhead.

Realization of the embodiments of the present patent application is immediately applicable to narrowband visible light, wired or underwater acoustic applications but could be used in any type of other communication including HomePlug, satellite systems and quantum communications to increase the robustness of the link by using multi-layer Fractal marking scheme, increase the reliability within a network by using automated run-time error recognition, and/or improve the final link quality by using adaptive dynamic cross layer coordination.

In the above embodiments, the real-time visible light sensor is used with dual color LED modules operating as front end and overlaid high speed embedded processor as back end. A major obstacle to overcome is the rapidly changing link impairment, including but not limited to errors, loss, adding of bytes or bits and loss of synchronizations, causing unknown failure of connected car applications. Because of the real-time element of the sensor, information has to be retained. A request for re-transmission of sensor data, when data loss, repeating or mess up of orders occur, is unacceptable. Failure to correct end to end data impairment will result in the loss of integrity of sensor data and severely limit the reliability of the sensor system for the continuity of provision of precise car locations and speeds.

The embodiments effectively eliminate the chance of misinterpretation of disordered data in the visible light band and high-speed moving platform ad hoc network applications. It does so with (a) imposing a multi-dimensional byte counter on the sensor data stream before transport and (b) counting the received byte after the transport and verifying against the coded number in the marker of the second color. The unique multi-dimensional counting and coding methodology is optimized for real-time visible light sensors, resulting in maximum reliability with minimal latency and bandwidth overhead. All embedded firmware system implementations are supported.

With the embodiments of the present patent application, an upper layer multi-dimensional interleaved counting method of dealing with disordered information is combined with a lower level combined counting and repetitive coding method to maintain the integrity of information. By matching the intrinsic upper layer application profile such as its Fractal Hurst Correlation length with the lower layers of transport profiles such as the counting unit length, the performance of each application is enhanced without compromising for a “one-fits-all” lower layer Forward Error Correction (FEC) coding algorithm The sensor data can be the GPS position of a car or its speed, the data may be compressed in time or space, and the multi-color LED light can be a third party system that can partially penetrate fog. The information to be sent is first divided into a minimum unit according to its correlation lengths. By the application of a layer wrapper in a multi-dimensional interleaving fashion, e.g., the different levels of stream restart markers and the number of bytes in each minimum unit is counted, the number is sent in the unit mark before the actual transmission. After finishing the transmission, the number is sent again in the transmission unit mark repetition coded with current mark and also its previous marks. The receiver first counts the number of bytes in the unit and then compares it with the number in mark. If the two agree with each other, a correct conclusion can be drawn. Otherwise, the receiver decodes the coded marks and makes additional judgment about which one is right or wrong. If the error is beyond the coding capability from all dimensions, and the probability is extreme low, it informs the sender to resend only the additional mark and not the actual data, because the data is bulky while the coded mark is small. It is noted that it is possible to promote this algorithm into LTE/WiMAX or 5G systems, standardizing it for the Internet of Things transportation protocols.

While the present patent application has been shown and described with particular references to a number of embodiments thereof, it should be noted that various other changes or modifications may be made without departing from the scope of the present invention.

What is claimed is:

1. A system for green communication for intelligent mobile internet of things, the system comprising:
a lead communication device; and
at least one mobile communication device; wherein the lead communication device is configured to communicate with each of the at least one mobile communication device, to determine a current communication environment between the lead communication device and the mobile communication device, and to control the operating mode of the mobile communication device according to the current communication environment.

2. The system of claim 1, wherein the lead communication device is configured to communicate with each of the at least one mobile communication device through visible light communication.

3. The system of claim 2, wherein the lead communication device and each of the at least one mobile communication device are configured to perform front, back and side object detection, information interaction, emergency event reminders and driver assistance functions through the communication.

4. The system of claim 1, wherein the lead communication device and each of the at least one mobile communication device are configured to form a network, to be nodes of the network, to act as routers in the network, and to transmit multimedia information to other nodes of the network by using information shaping and compensation algorithms in a digital signal processing format.

5. The system of claim 4, wherein the lead communication device and each of the at least one mobile communication device are configured to use an artificial intelligence algorithm to find missing bits, remove extra error bits, and correct flipped bits within the communication, the artificial intelligence algorithm containing a neural network that evolves by itself.

6. The system of claim 4, wherein the lead communication device and each of the at least one mobile communication device are configured to transmit information to other networks through a roadside unit.

7. The system of claim 4, wherein the lead communication device and each of the at least one mobile communication device are configured to combine side implicit information generated by a frame marker so as to reduce error rate and improve reliability of the communication.

8. The system of claim 1, wherein the lead communication device and each of the at least one mobile communication device respectively comprise an interpolator for concealing errors in a damaged block of information of an information stream that comprises a plurality of blocks of information, the interpolator being configured to determine the distance between a damaged block and an undamaged block of information in the information stream and to apply a weight based on the distance to thereby interpolate the damaged block.

9. The system of claim 8, wherein the weight is one of a plurality of weights that follow a Fractal distribution proportional to the distance.

10. The system of claim 1, wherein the lead communication device and each of the at least one mobile communication device respectively comprise an interleaving system, the interleaving system comprising an input configured to receive information and a plurality of interleavers having respective associated interleaving lengths, each interleaver being configured to interleave the information according to its respective associated interleaving length.

11. The system of claim 10, wherein the lead communication device and each of the at least one mobile communication device respectively comprise a de-interleaving system, the de-interleaving system comprising an input configured to receive information and a plurality of de-interleavers having respective associated de-interleaving lengths, each de-interleaver being configured to de-interleave the information according to its respective associated de-interleaving length.

12. The system of claim 1 further comprising means for receiving information over a communication link, means for analyzing the received information to determine conditions of the communication link, means for adapting an interleaving length based on the determined conditions, and means for interleaving the information to be subsequently transmitted on the communication link using the adapted interleaving length.

13. The system of claim 10, wherein the interleaving system comprises color coded markers for transmitting and receiving the interleaving length information, in front of and behind data, wherein the position of the interleaving length information in an interleaved data stream is controlled based on the interleaving length.

14. The system of claim 11, wherein the de-interleaving system comprises an input for receiving marked information and an input for receiving a marker.

15. The system of claim 1 further comprising means for receiving a signal from a camera; means for checking whether a frame length is correct; means for using a first neural network to detect speed of the mobile communication device if the frame length is not correct; and means for using a second neural network to correct the error first and then displaying information associated with the signal.

16. The system of claim 15, wherein the first neural network and the second neural network have the same structure but trained by different data, while the first neural network utilizes an atomic clock.

17. A method for green communication for intelligent mobile internet of things, the method comprising:
communicating with at least one mobile communication device by a lead communication device through visible light communication;
determining the current communication environment between the lead communication device and the mobile communication device;
controlling the operating mode of the mobile communication device according to the current communication environment; and
forming a network with nodes of the network being the lead communication device and the at least one mobile communication device, configuring the lead communication device and the at least one mobile communication device as routers in the network, and transmitting multimedia information to other nodes of the network by using information shaping and compensation algorithms in a digital signal processing format.

18. The method of claim 17 further comprising using an artificial intelligence algorithm to find missing bits, remove extra error bits, and correct flipped bits within the communication, the artificial intelligence algorithm containing a neural network that evolves by itself.

19. A method for green communication for intelligent mobile internet of things, the method comprising:
communicating with at least one mobile communication device by a lead communication device through visible light communication;
determining the current communication environment between the lead communication device and the mobile communication device;
controlling the operating mode of the mobile communication device according to the current communication environment;
forming a network with nodes of the network being the lead communication device and the at least one mobile communication device, configuring the lead communication device and the at least one mobile communication device as routers in the network, and transmitting multimedia information to other nodes of the network by using information shaping and compensation algorithms in a digital signal processing format; and
transmitting information of the lead communication device and the mobile communication device and collected traffic information to other networks through a roadside unit.

20. The method of claim 19 further comprising repairing errors in communication with a combined algorithm of predictive blind compensation and shaping, the algorithm comprises removing repeating errors or missed information using boundary markers, the boundary makers being inserted periodically to a side channel.
